(19) United States
(12) Patent Application Publication
(10) Pub. No.: US 2008/0008383 A1
(43) Pub. Date: Jan. 10, 2008

(54) Detection and identification of postal metermarks

(75) Inventors: Richard S. Andel, Binghamton, NY (US); Robert S. Lunt, Endicott, NY (US)

Correspondence Address: TAROLLI, SUNDHEIM, COVELL & TUMMINO LLP, Suite 1700, 1300 East Ninth Street, CLEVELAND, OH, 44114, US

(73) Assignee: Lockheed Martin Corporation

(21) Appl. No.: 11/482,423

(22) Filed: Jul. 7, 2006

(51) Int. Cl. G06K 9/34; G06K 9/46; G06K 9/62; G06K 9/66

(52) U.S. Cl. 382/173; 382/190; 382/225

(57) ABSTRACT

A system is presented for metermark recognition. This includes a plurality of binarization elements, each being operative to produce a binarized image from a source image. A clustering element clusters pixels within a first binarized image, produced at a first of the plurality of binarization elements, to locate at least one character string. A classification element identifies a plurality of characters comprising the located character string. A verification system evaluates the identified plurality of characters and instructs a second of the plurality of binarization elements to produce a second binarized image if the identified characters are determined to be unreliable.

### BACKGROUND OF THE INVENTION

In mail handling application, a limited amount of time is available to make a decision about an envelope provided to a system. For example, postal indicia and at least a portion of the address text on an envelope or package must be scanned, located, and recognized in a period on the order of one hundred milliseconds to maintain the flow of mail through the system. These time constraints limit the available solutions for accurately classifying various elements on an envelope.

While detection and recognition of text and common postal indicia are complicated by these time constraints, recognition of metermarks provides special problems for a number of reasons. To begin with, metermarks tend to suffer from irregular print quality, both among and within the various metermark machines in circulation. Accordingly, it is difficult to acquire a reliable, low-noise, high intensity image of a metermark for analysis. Additionally, there is significant variety in the metermark formats encountered in a given population of letters, each of which features a different arrangement of desired information (e.g., postage value, meter number, etc.) within the mark. This makes it difficult to instate a standard process for locating the information. Each of these metermark formats can also contain a large amount of extraneous markings that can be confused with the desired information. Other indicia that is on the envelope is sometimes very similar to the metermark format, also making it more difficult to determine what indicia is actually a valid metermark.

### SUMMARY OF THE INVENTION

In accordance with one aspect of the present invention, a system is presented for metermark value recognition. This includes a plurality of binarization elements, each being operative to produce a binarized image from a source image. A clustering element clusters pixels within a first binarized image, produced at a first of the plurality of binarization elements, to locate at least one character string. A classification element identifies a plurality of characters comprising the located character string. A verification system evaluates the identified plurality of characters and instructs a second of the plurality of binarization elements to produce a second binarized image if the identified characters are determined to be unreliable.

In accordance with another aspect of the present invention, a computer program product, operative in a data processing system and stored on a computer readable medium, is provided that determines an associated value of a metermark. An image processing element is operative to produce a first binarized image via a first binarization technique and a second binarized image via a second binarization technique. A region identifier identifies a plurality of regions of connected pixels in the first binarized image. A clustering element combines the identified regions into at least one character string. A given character string comprises a plurality of characters. An optical character recognition system classifies each of the plurality of characters comprising a given string into one of a plurality of character classes. A string verification element determines a confidence value for a given string according to its classified plurality of characters, accepts the string if the confidence value meets a threshold value, and provides a reject signal to the image processing unit to instruct the image processing unit to produce the second binarized image if the confidence value does not meet a threshold value.

In accordance with yet another aspect of the present invention, a system for metermark value recognition is provided. A plurality of binarization elements are each operative to produce a binarized image from a source image. A clustering element clusters pixels within a first binarized image, produced at a first of the plurality of binarization elements, to locate at least one character string. A classification element identifies a plurality of characters comprising the located character string. A verification system evaluates the identified plurality of characters and instructs a second of the plurality of binarization elements to produce a second binarized image if the identified characters are determined to be unreliable.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a metermark processing system that locates and recognizes at least one character sting from a metermark on an envelope in accordance with an aspect of the present invention;

FIG. 2 illustrates a graphical representation of four image formats associated with an exemplary image processing component in accordance with an aspect of the present invention;

FIG. 3 illustrates an exemplary artificial neural network classifier;

FIG. 4 illustrates an exemplary implementation of a metermark processing system in accordance with an aspect of the present invention;

FIG. 5 illustrates a methodology for reading postal value from a scanned metermark in accordance with an aspect of the present invention;

FIG. 6 illustrates an exemplary image processing system for a mail handling system in accordance with an aspect of the present invention;

FIG. 7 illustrates an exemplary mail handling system incorporating a metermark value recognition system in accordance with an aspect of the present invention; and

FIG. 8 illustrates a computer system that can be employed to implement systems and methods described herein, such as based on computer executable instructions running on the computer system.

### DETAILED DESCRIPTION OF THE INVENTION

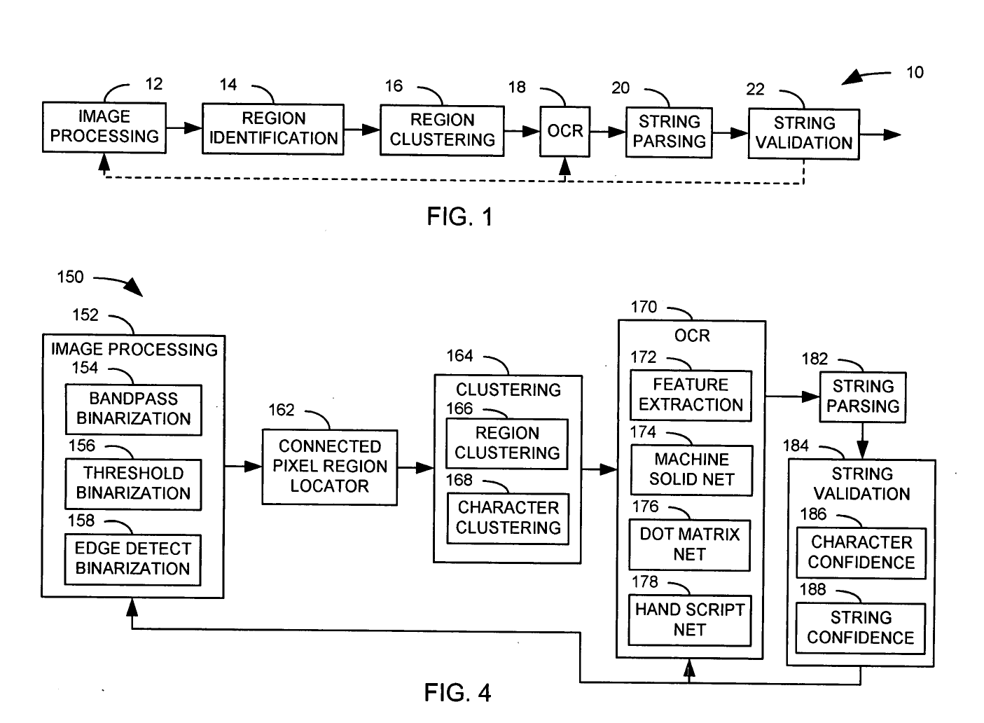

The present invention relates to systems and methods for extracting information, such as postal value information from a metermark on an envelope. FIG. 1 illustrates a metermark processing system 10 that locates and recognizes at least one character sting from a metermark on an envelope in accordance with an aspect of the present invention. The illustrated system 10 provides an efficient, robust process for extracting character strings from a metermark as to limit errors caused by varying metermark formats and irregular printing.

It will be appreciated that the illustrated system 10 is designed to extract desired character data from a metermark in an extremely short period of time, generally on the order of tens of milliseconds. During this time, the system can utilize a number of different image processing algorithms and classification techniques in a waterfalling arrangement such that a new technique can be explored whenever a previous technique fails to achieve a desired level of confidence. The techniques are selected to be computationally inexpensive and diverse, such that each technique is particularly effective for metermarks having certain characteristics. Since the techniques, taken separately, are computationally inexpensive, the system 10 can cycle quickly through the various techniques, allowing for accurate recognition of a wide range of metermark images.

During operation, one or more metermark images are provided to an image processing component 12. It will be appreciated that these images can comprise grayscale, color, or ultraviolet florescence images of various resolutions as well as binarized images of the envelope. The image processing component 12 is operative to apply one of a plurality of binarization algorithms to a received image. A given binarization algorithm reviews one or more values, generally including a brightness value, associated with each of a plurality of pixels comprising a greyscale or color image to convert each pixel to a single bit. Basically, in a binarized image, each pixel is represented by a single bit as “dark” or “white”.

An image representing a particular binarization algorithm can be selected at the image processing element 12 and provided to a region identification element 14. It will be appreciated that the selected image need not be generated at the image processing element, and that the selected image can comprise a received image that was provided in binary form. At the region identification element 14, regions of connected pixels are identified by the system and marked with axis aligned bounding boxes. In an exemplary implementation, the regions of connected pixels comprise regions of horizontally or vertically connected pixels.

A region clustering element 16 combines spatially proximate identified regions into characters and strings. In an exemplary implementation, the region clustering element 16 combines regions within a threshold distance to create larger bounded regions. After one or more passes, using either the same or different distance thresholds, the regions groups are considered to represent individual characters. The characters can then be combined into character strings for analysis. For example, the strings can be grouped together according to similarities in height, similarities in horizontal midlines, and horizontal proximity.

Any identified strings are then provided to an optical character recognition (OCR) system 18 that classifies each of the plurality of characters comprising a given string as one of a plurality of possible characters (e.g., alphanumeric characters, special characters, etc.). In accordance with an aspect of the present invention, the optical character recognition system 18 can utilize multiple classifiers, each having an associated classification technique, applied in a waterfalling arrangement, to classify character strings having varying characteristics.

A string parsing element 20 reviews any classified string for contextual evidence to determine if it contains information of interest, such as postal value information. For example, characters such as decimal points, dollar signs, colons, and superscripted numbers at appropriate locations within the string provide an indication that the string contains value information.

A string validation element 22 determines a confidence value for each string and compares the determined confidence to a threshold value. In an exemplary implementation, the determined confidence is a function of a classification confidence associated with each of the plurality of characters comprising the string and any contextual evidence that the string contains value information. If the determined confidence value exceeds a threshold value, which is usually determined based on the sample data, a postage value represented by the string is accepted as the system output.

Where the confidence associated with a string falls below a threshold value, the string can be sent back to the OCR system 18, where a second classification technique can be selected to classify the data. Once a predetermined sequence of classification techniques have been utilized without producing a sufficiently large confidence value, a reject message can be provided back to the image processing component 12. In response, the image processing component 12 can generate a new binarized image, associated with a second binarization algorithm, and provide the new binarized image to the region identification element 14 for a second round of analysis. This can be repeated to utilize additional binarization algorithms, assuming the metermark is not read with sufficient confidence using the second binarization algorithm, until a predetermined number of algorithms are utilized or a predetermined period of time has passed. At this point, the metermark is rejected and an unknown value returned to the main processing program, or in some cases forwarded for manual processing.

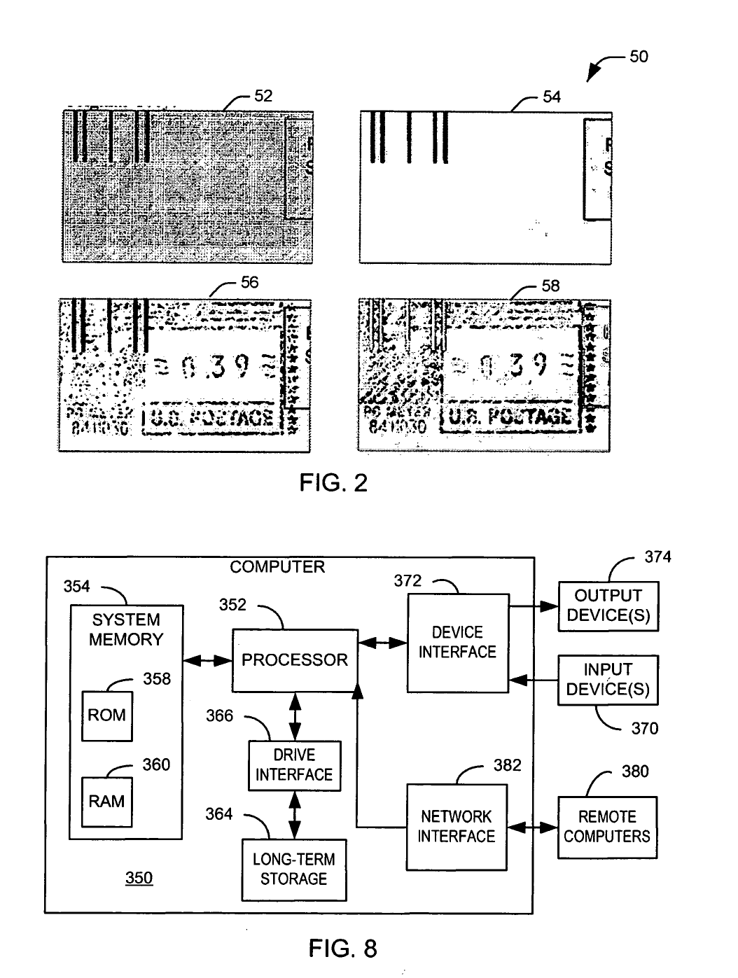

FIG. 2 provides a graphical representation 50 of four image formats associated with an exemplary image processing component in accordance with an aspect of the present invention. Specifically, FIG. 2 illustrates a grayscale image 52 that can be provided to an image processing component in accordance with an aspect of the present invention. It will be appreciated that the grayscale image 52 shows considerable diagonal banding, such that the information within the metermark is partially obscured. Such banding is not uncommon in scanned metermarks. This diagonal banding, along with the relatively low contrast in the scanned image, renders the grayscale image poorly suited for metermark value recognition.

To avoid these problems, the grayscale image can be binarized, such that each pixel is assigned a single bit binary value representing a “dark” pixel or a “white” pixel. This can be accomplished in several ways, including a thresholding function that assigns pixels above a threshold brightness to “white” and below a threshold value to “dark,” a bandpass function where only pixels within a defined range of brightness are assigned to “dark”, and an edge detection algorithm. It will be appreciated that each of these methods has its own unique strengths and weaknesses with respect to certain types of image data, such that for a scanned metermark image, the performance of the various binarization techniques can vary significantly.

For example, a first binarized image 54 can be produced from the grayscale image 52 via a first binarization algorithm. In the illustrated example, the first binarization algorithm is ill-suited for the characteristics of grayscale image 52, producing an image 54 i which nearly all of the detail has been washed out during binarization. A second binarized image 56 utilizes a second binarization algorithm, retaining significantly more detail. It will be appreciated, however, that many of the characters in the second binarized image are badly fragmented, to the point where recognition could be complicated.

A third binarized image 58 is produced via a third binarization algorithm. The third binarized image 58 contains significantly more detail, but also contains a larger amount of noise. In accordance with each of an aspect of the present invention, each of these binarized images 54, 56, and 58 could be provided sequentially to an optical character recognition system that is comprised of an artificial neural network classifier until a recognition having a sufficient level of confidence is achieved.

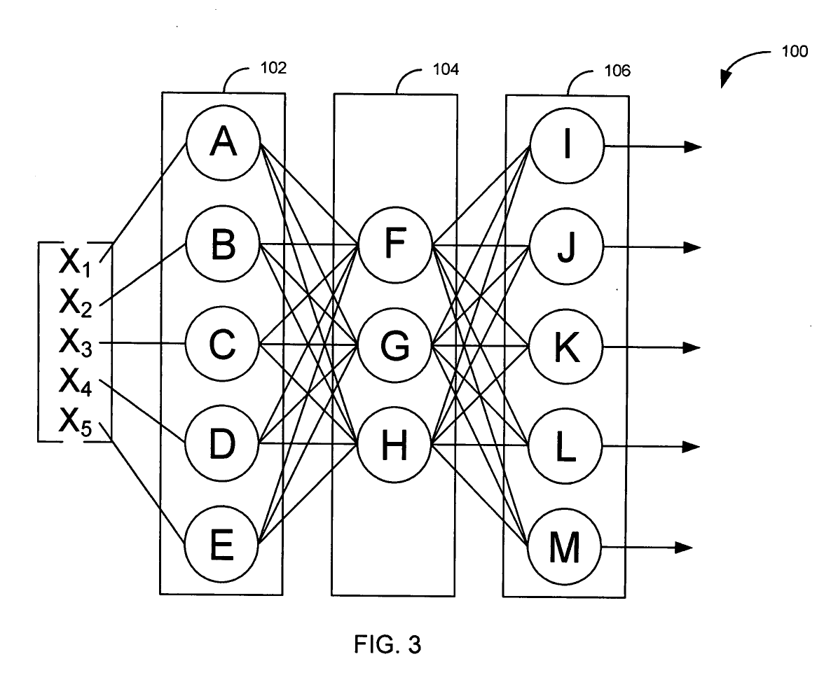

FIG. 3 illustrates an exemplary artificial neural network classifier 100. The illustrated neural network is a three-layer back-propagation neural network suitable for use in an elementary pattern classifier. It should be noted here, that the neural network illustrated in FIG. 4 is a simple example solely for the purposes of illustration. Any non-trivial application involving a neural network, including pattern classification, would require a network with many more nodes in each layer and/or additional hidden layers. It will further be appreciated that a neural network can be implemented in hardware as a series of interconnected hardware processors or emulated as part of a software program running on a data processing system.

In the illustrated example, an input layer 102 comprises five input nodes, A-E. A node, or neuron, is a processing unit of a neural network. A node may receive multiple inputs from prior layers which it processes according to an internal formula. The output of this processing may be provided to multiple other nodes in subsequent layers.

Each of the five input nodes A-E receives input signals with values relating to features of an input pattern. Preferably, a large number of input nodes will be used, receiving signal values derived from a variety of pattern features. Each input node sends a signal to each of three intermediate nodes F-H in a hidden layer 104. The value represented by each signal will be based upon the value of the signal received at the input node. It will be appreciated, of course, that in practice, a classification neural network can have a number of hidden layers, depending on the nature of the classification task.

Each connection between nodes of different layers is characterized by an individual weight. These weights are established during the training of the neural network. The value of the signal provided to the hidden layer 104 by the input nodes A-E is derived by multiplying the value of the original input signal at the input node by the weight of the connection between the input node and the intermediate node (e.g., G). Thus, each intermediate node F-H receives a signal from each of the input nodes A-E, but due to the individualized weight of each connection, each intermediate node receives a signal of different value from each input node. For example, assume that the input signal at node A is of a value of 5 and the weights of the connections between node A and nodes F-H are 0.6, 0.2, and 0.4 respectively. The signals passed from node A to the intermediate nodes F-H will have values of 3, 1, and 2.

Each intermediate node F-H sums the weighted input signals it receives. This input sum may include a constant bias input at each node. The sum of the inputs is provided into a transfer function within the node to compute an output. A number of transfer functions can be used within a neural network of this type. By way of example, a threshold function may be used, where the node outputs a constant value when the summed inputs exceed a predetermined threshold. Alternatively, a linear or sigmoidal function may be used, passing the summed input signals or a sigmoidal transform of the value of the input sum to the nodes of the next layer.

Regardless of the transfer function used, the intermediate nodes F-H pass a signal with the computed output value to each of the nodes I-M of the output layer 106. An individual intermediate node (i.e. G) will send the same output signal to each of the output nodes I-M, but like the input values described above, the output signal value will be weighted differently at each individual connection. The weighted output signals from the intermediate nodes are summed to produce an output signal. Again, this sum may include a constant bias input.

Each output node represents an output class of the classifier. The value of the output signal produced at each output node is intended to represent the probability that a given input sample belongs to the associated class. In the exemplary system, the class with the highest associated probability is selected, so long as the probability exceeds a predetermined threshold value. The value represented by the output signal is retained as a confidence value of the classification.

FIG. 4 illustrates an exemplary implementation of a metermark processing system 150 in accordance with an aspect of the present invention. It will be appreciated that the illustrated system can be implemented as specialized hardware, software, or any combination thereof. An image processing component 152 is operative to produce binarized representation of one or more received images of a metermark. It will be appreciated that the received images can comprise grayscale and color images of various resolutions as well as binarized images of the envelope.

The image processing component 152 can comprise a plurality of binarization components 154, 156, and 158 that are operative to produce binarized images according to associated binarization elements. In the illustrated implementation, three binarization elements are used. A thresholding binarization element 154 that assigns pixels as “white” and “dark” according to a threshold comparison of the pixel brightness. A bandpass binarization element 156 assigns pixels within a defined range of brightness to “dark” and all other pixels to “white”. An edge detection binarization algorithm 158 assigns dark pixels to the image according to detected edges within the grayscale image.

The image processing component 152 selects a binarization element and provides a binarized image associated with the selected binarized element to a region identification element 162. It will be appreciated that the binarization element can be selected according to one or more characteristics of the input metermark image. For example, when the input image represents a full metermark, a first binarization element can be selected, and when the image represents only a postmark value, as second binarization element can be selected.

At the region identification element 162, regions of connected pixels are identified by the system and marked with axis aligned bounding boxes. In an exemplary implementation, only 4-connected regions of pixels are selected, meaning that a given region can comprise horizontal or vertical connections between pixels. The identified regions are then provided to a clustering element 164 for analysis.

The clustering element 164 is operative to identify character strings from the identified regions. To this end, the clustering element 164 can comprise a region clustering routine 166 that combines the identified regions into characters, and a character clustering element 168 that combines the characters into character strings. The region clustering element 164 combines spatially proximate identified regions into characters and strings. In the illustrated implementation, the region clustering element 164 scans through the image and combines any two regions separated by less than a threshold distance to create larger bounded regions. Once the region clustering element 164 has completed one scan, one or more scans can be made, for example, with a larger distance threshold, in an attempt to ensure that all fragmented characters have been rejoined.

At the character clustering element 166, the combined regions, which are believed to represent characters, are combined into character strings for analysis. For example, the combined regions can be grouped together according to their common characteristics. For example, horizontally proximate combined regions can be combined when they are similar in height and vertical centering. Once one or more strings have been found, each string can be expanded in an attempt to include punctuation, subscripts, and superscripts associated with the string.

Any located character strings are then provided to an optical character recognition (OCR) system 170 that attempts to recognize individual characters within the strings. The OCR system 170 includes a feature extractor 172 that extracts features from the region of the image representing a given character. The feature extractor 172 derives a vector of numerical measurements, referred to as feature variables, from the image region. Thus, the feature vector represents the image in a modified format that attempts to represent various aspects of the original image. It will be appreciated that the feature extractor 172 can be operative to extract features, in the form of feature vectors, for a plurality of classifiers 174, 176, and 178 in the OCR system 170.

The features used to generate a given feature vector will be specific to its associated classifier. The features utilized for a given classifier are selected both for their effectiveness in distinguishing among a plurality of possible characters and for their ability to be quickly extracted from the image sample, such that the extraction and classification processes can take place in real-time.

The extracted feature vector is then provided to one of a plurality of classification systems 174, 176, and 178. A selected classification system classifies each envelope image to determine an associated orientation for the envelope from a plurality of possible orientations. The classification algorithm selected for a given string can be selected according to characteristics of the string to be classified.

For example, the default classifier used for the system is an artificial neural network classifier 174 that has been designed to identify machine printed text that can have characters that are not completely formed. But when the characters comprising the string are heavily fragmented, a dot matrix neural network classifier 176 can be utilized. The dot matrix neural network classifier 176 is optimized for identifying characters as highly fragmented groups of regions. If the selected classifier fails to achieve a classification result having a desired level of confidence, a hand script neural network 178 can be used. The hand script neural network 178 is designed for recognizing hand written characters, making it ideal for recognizing characters having irregular characteristics, such as unusual aspect ratios.

Once the individual characters have been classified, the strings are passed to a string parsing element 182 that reviews the classified string for contextual evidence to determine if it contains information of interest, such as postal value information. The contextual evidence can include any characteristics of the string that would indicate that the string contains value information.

For example, a string containing exactly one decimal point with two or three numeric digits following would provided contextual evidence of value information. Similar, the presence of an unusual metermark character such as a leading and/or trailing triple-tilde character or the presence of a dollar sign to the left of a string of digits is indicative that the string provides value information. Likewise, the presence of a superscript numeric to the right of a string of digits, or the presence of a colon to the right of a string of digits indicates that the string represents a postage value.

A string validation element 184 determines a confidence value for each string and compares the determined confidence to a threshold value. A character confidence element 186 calculates a confidence value for the string as a function of a classification confidence associated with each of the plurality of characters comprising the string. For example, the confidence value can comprise a weighted average or sum of the confidence values associated with the plurality of characters. This confidence value can be modified at a string confidence element 188 according to any contextual evidence that the string contains value information.

If the determined confidence value exceeds a threshold value, a postage value represented by the string is accepted as the system output. Where the confidence associated with a string falls below a threshold value, the string can be sent back to the OCR system 170, where a second classification technique (e.g., the hand script neural network 178) can be selected to classify the data. If the OCR system 170 is unsuccessful in classifying the string, a reject message can be provided back to the image processing component 152. In response, the image processing component 152 can generate a new binarized image, associated with a second binarization algorithm, and provide the new binarized image to the region identification element 162 for another analysis of the metermark value. This can be repeated to utilize additional binarization algorithms, assuming the metermark is not read with sufficient confidence using the second binarization algorithm, until a predetermined number of algorithms are utilized or a predetermined period of time has passed. At this point, the metermark is rejected and an unknown value returned to the main processing program, or in some cases forwarded for manual processing.

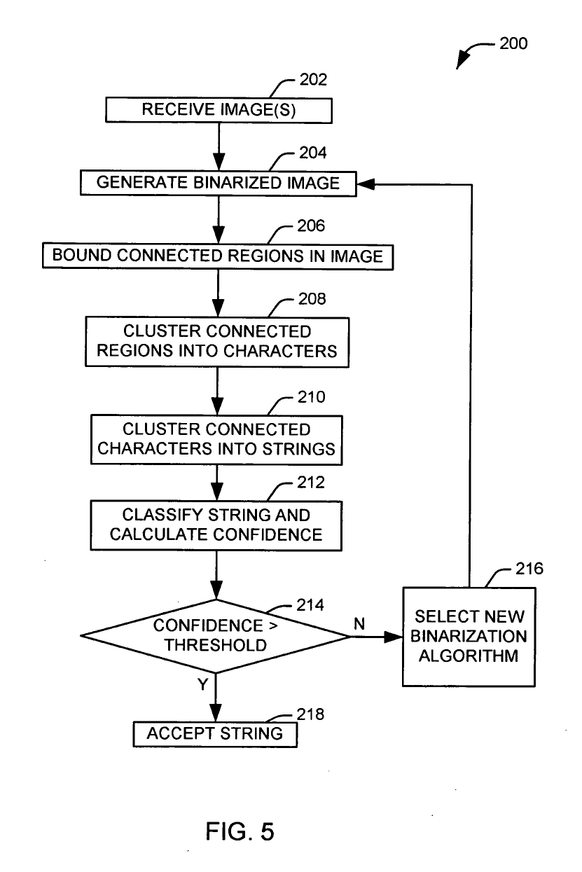

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 5 illustrates a methodology 200 for reading postal value from a scanned metermark in accordance with an aspect of the present invention. At step 202, one or more metermark images are received for processing. It will be appreciated that these images can comprise grayscale and color images of various resolutions as well as binarized images of the metermark. The received images can be used at step 204 to generate a binarized image of the metermark for analysis. It will be appreciated that the binarized image can be provided with the received images or generated according to a first binarization algorithm.

At step 206, regions of connected pixels are identified by the system and marked with axis aligned bounding boxes. In an exemplary implementation, the regions of connected pixels comprise regions of horizontally or vertically connected pixels, but not diagonally connected pixels. At step 208, the marked regions are clustered into characters. For example, any pair of two regions within a threshold distance of one another can be combined to create larger bounded regions. At step 210, the characters clusters generated at step 208 are combined into character strings. For example, groups of characters that are similar in height, horizontally proximate, and having roughly the same vertical center can be associated to form a character string.

At step 212, each of the characters comprising an identified string is classified as one of a plurality of possible characters. The classified string is reviewed any classified string for contextual evidence to determine if it contains postal value information. From the individual classifications and the contextual evidence, a confidence value is determined for the string.

At step 214, the determined confidence value is compared to a threshold value. Where the confidence associated with a string falls does not meet the threshold value (N), the classified string is rejected and the methodology advances to step 216, where a new binarization technique is selected. The methodology then returns to step 204 to generate a new binarized image utilizing the selected binarization technique. Where the confidence associated with a string meets the threshold value (Y), the string is accepted as the postal value at step 218.

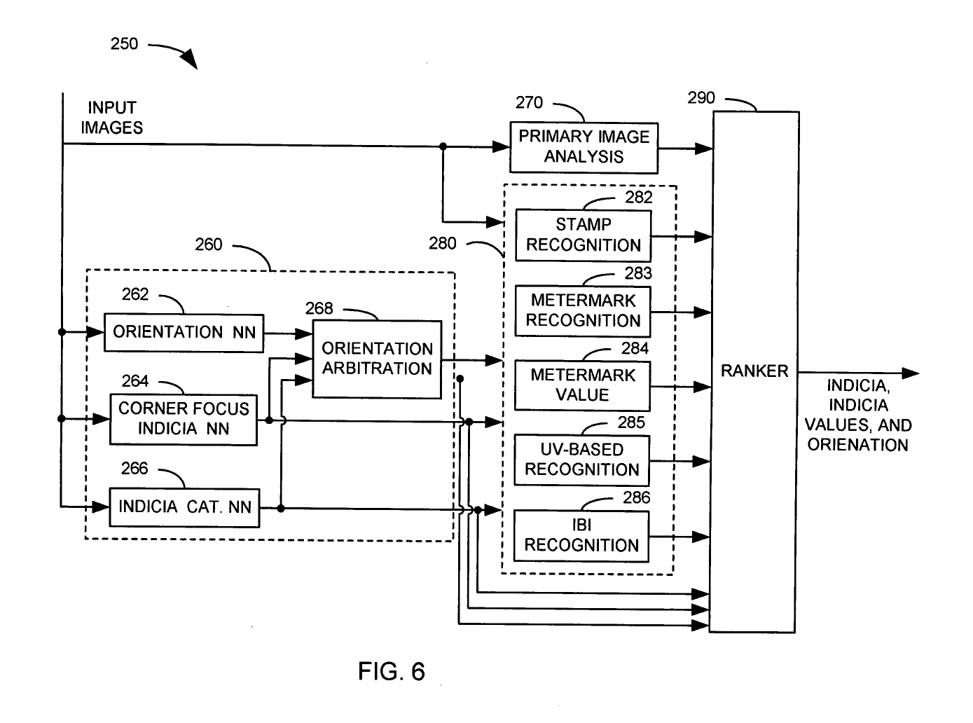

FIG. 6 illustrates an exemplary image processing system 250 for a mail handling system in accordance with an aspect of the present invention. The image processing system 250 can be roughly divided into two sequential stages. In a first stage, the orientation and facing of the envelope are determined as well as general information relating to the types of indicia located on the envelope. During the first processing stage, an orientation determination element 260 can be initiated to provide an initial determination of the orientation and facing of the envelope. In accordance with an aspect of the present invention, the first stage of image processing is designed to operate within less than one hundred eighty milliseconds.

One or more images can be provided to the orientation determination element 260 as part of the first processing stage. A plurality of neural network classifiers 262, 264, and 266 within the orientation determination element 260 are operative to analyze various aspects of the input images to determine an orientation and facing of the envelope. A first neural network classifier 262 determines an appropriate orientation for the envelope according to the distribution of dark pixels across each side of the envelope. A second neural network classifier 264 can comprise an indicia detection and recognition system that locates dense regions within the corners of an envelope and classifies the located dense regions into broad indicia categories. A third neural network classifier 266 can review information related to four different corners (two front and two back) to determine the presence and type, if present, of postal indicia within these regions.

The outputs of all three neural network classifiers 262, 264, and 266 are provided to an orientation arbitrator 268. The orientation arbitrator 268 determines an associated orientation and facing for the envelope according to the neural network outputs. In the illustrated implementation, the orientation arbitrator 268 is a neural network classifier that receives the outputs of the three neural network classifiers 262, 264, and 266 and classifies the envelope into one of four possible orientations.

Once an orientation for the envelope has been determined, a second stage of processing can begin. During the second stage of processing, one or more primary image analysis elements 270, various secondary analysis elements 280, and a ranking element 290 can initiate to provide more detailed information as to the contents of the envelope. In accordance with an aspect of the present invention, the second stage is operative to run in approximately two thousand two hundred milliseconds. It will be appreciated that during this time, processor resources can be shared among a plurality of envelopes.

The primary image analysis elements 270 are operative to determine one or more of indicia type, indicia value, and routing information for the envelope. Accordingly, a given primary image analysis element 270 can include a plurality segmentation routines and pattern recognition classifiers that are operative to recognize postal indicia, extract value information, isolate address data, and read the characters comprising at least a portion of the address. It will be appreciated that multiple primary analysis elements 270 can analyze the envelope content, with the results of the multiple analyses being arbitrated at the ranking element 290.

The secondary analysis elements 280 can include a plurality of classification algorithms that review specific aspects of the envelope. In the illustrated implementation, the plurality of classification algorithms can include a stamp recognition classifier 282 that identifies stamps on an envelope via template matching, a metermark recognition system 283, a metermark value recognition system 284 in accordance with the present invention, one or more classifiers 285 that analyze an ultraviolet florescence image, and a classifier 286 that identifies and reads information based indicia (ISI).

It will be appreciated that the secondary analysis elements 280 can be active or inactive for a given envelope according to the results at the second and third neural networks 264 and 266. For example, if it is determined with high confidence that the envelope contains only a stamp, the metermark recognition element 283, metermark value recognition element 284, and the IBI based recognition element 286 can remain inactive to conserve processor resources.

The outputs of the orientation determination element 260, the primary image analysis elements 270, and the secondary analysis elements 280 are provided to a ranking element 290 that determines a final output for the system 250. In the illustrated implementation, the ranking element 290 is a rule based arbitrator that determines at least the type, location, value, and identity of any indicia on the envelope according to a set of predetermined logical rules. These rules can be based on known error rates for the various analysis elements 260, 270, and 280. The output of the ranking element 290 can be used for decision making throughout the mail handling system.

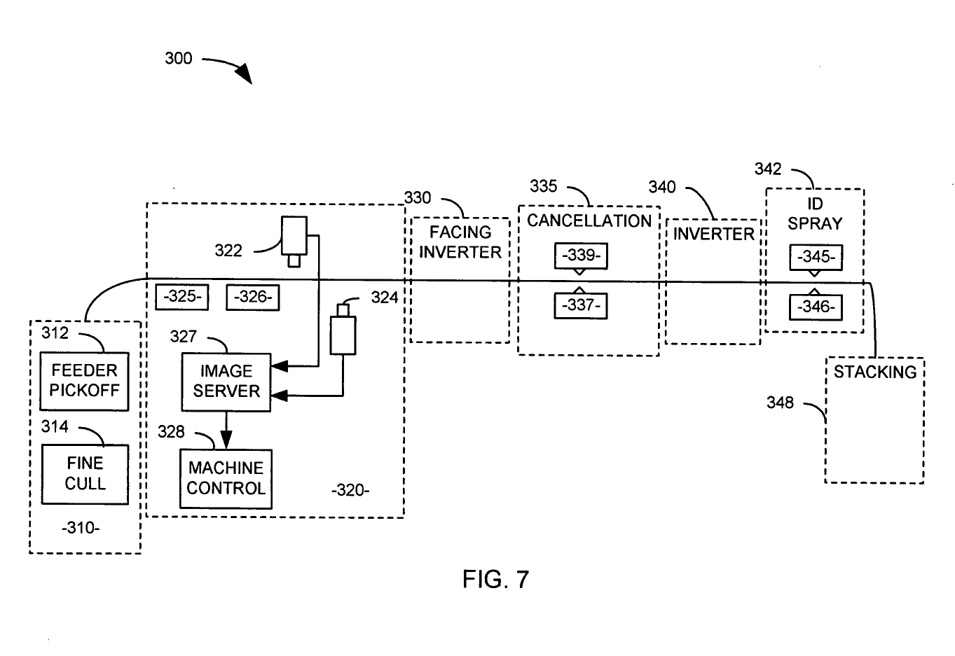

FIG. 7 illustrates an exemplary mail handling system 300 incorporating a metermark value recognition system in accordance with an aspect of the present invention. The mail sorting system 300 comprises a singulation stage 310, an image lifting stage 320, a facing inversion stage 330, a cancellation stage 335, an inversion stage 340, an ID tag spraying stage 344, and a stacking stage 348. One or more conveyors (not shown) would move mailpieces from stage to stage in the system 300 (from left to right in FIG. 7) at a rate of approximately 3.6-4.0 meters per second.

A singulation stage 310 includes a feeder pickoff 312 and a fine cull 314. The feeder pickoff 312 would generally follow a mail stacker (not shown) and would attempt to feed one mailpiece at a time from the mail stacker to the fine cull 314, with a consistent gap between mailpieces. The fine cull 314 would remove mailpieces that were too tall, too long, or perhaps too stiff. When mailpieces left the fine cull 314, they would be in fed vertically (e.g., longest edge parallel to the direction of motion) to assume one of four possible orientations.

The image lifting station 320 can comprise a pair of camera assemblies 322 and 324. As shown, the image lifting stage 320 is located between the singulation stage 310 and the facing inversion stage 330 of the system 300, but image lifting stage 320 may be incorporated into system 300 in any suitable location.

In operation, each of the camera assemblies 322 and 324 acquires both a low-resolution UV image and a high-resolution grayscale image of a respective one of the two faces of each passing mailpiece. Because the UV images are of the entire face of the mailpiece, rather than just the lower one inch edge, there is no need to invert the mailpiece when making a facing determination.

Each of the camera assemblies 322 and 324 illustrated in FIG. 7 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of multiple sides of a mailpiece. Similarly, optical processing, such as through the use of mirrors, could allow a single camera assembly to capture images of multiple sides of a mailpiece.

Further, it should be appreciated that UV and grayscale are representative of the types of image information that may be acquired rather than a limitation on the invention. For example, a color image may be acquired. Consequently, any suitable imaging components may be included in the system 300.

As shown, the system 300 may further include an item presence detector 325, a belt encoder 326, an image server 327, and a machine control computer 328. The item presence detector 325 (exemplary implementations of an item presence detector can include a “photo eye” or a “light barrier”) may be located, for example, five inches upstream of the trail camera assembly 322, to indicate when a mailpiece is approaching. The belt encoder 326 may output pulses (or “ticks”) at a rate determined by the travel speed of the belt. For example, the belt encoder 326 may output two hundred and fifty six pulses per inch of belt travel. The combination of the item presence detector 325 and belt encoder 326 thus enables a relatively precise determination of the location of each passing mailpiece at any given time. Such location and timing information may be used, for example, to control the strobing of light sources in the camera assemblies 322 and 324 to ensure optimal performance independent of variations in belt speed.

Image information acquired with the camera assemblies 322 and 324 or other imaging components may be processed for control of the mail sorting system or for use in routing mailpieces passing through the system 300. Processing may be performed in any suitable way with one or more processors. In the illustrated embodiment, processing is performed by image server 327. It will be appreciated that, in one implementation, a metermark value recognition system in accordance with an aspect of the present invention, could be implemented as a software program in the image server 327.

The image server 327 may receive image data from the camera assemblies 322 and 324, and process and analyze such data to extract certain information about the orientation of and various markings on each mailpiece. In some embodiments, for example, images may be analyzed using one or more neural network classifiers, various pattern analysis algorithms, rule based logic, or a combination thereof. Either or both of the grayscale images and the UV images may be so processed and analyzed, and the results of such analysis may be used by other components in the system 300, or perhaps by components outside the system, for sorting or any other purpose.

In the embodiment shown, information obtained from processing images is used for control of components in the system 300 by providing that information to a separate processor that controls the system. The information obtained from the images, however, may additionally or alternatively be used in any other suitable way for any of a number of other purposes. In the pictured embodiment, control for the system 300 is provided by a machine control computer 328. Though not expressly shown, the machine control computer 328 may be connected to any or all of the components in the system 300 that may output status information or receive control inputs. The machine control computer 328 may, for example, access information extracted by the image server 327, as well as information from other components in the system, and use such information to control the various system components based thereupon.

In the example shown, the camera assembly 322 and 324 is called the “lead” assembly because it is positioned so that, for mailpieces in an upright orientation, the indicia (in the upper right hand corner) is on the leading edge of the mailpiece with respect to its direction of travel. Likewise, the camera assembly 324 is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 322, the image server 327 may determine an orientation of “flip” or “no-flip” for the inverter 330. In particular, the inverter 330 is controlled so that that each mailpiece has its top edge down when it reaches the cancellation stage 335, thus enabling one of the cancellers 337 and 339 to spray a cancellation mark on any indicia properly affixed to a mailpiece by spraying only the bottom edge of the path (top edge of the mailpiece). The image server 327 may also make a facing decision that determines which canceller (lead 337 or trail 339) should be used to spray the cancellation mark. Other information recognized by the image server 327, such as information based indicia (IBI), may also be used, for example, to disable cancellation of IBI postage since IBI would otherwise be illegible downstream.

After cancellation, all mailpieces may be inverted by the inverter 342, thus placing each mailpiece in its upright orientation. Immediately thereafter, an ID tag may be sprayed at the ID spraying stage 344 using one of the ID tag sprayers 345 and 346 that is selected based on the facing decision made by the image server 327. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces may ride on extended belts for drying before being placed in output bins or otherwise routed for further processing at the stacking stage 348. Except for rejects, the output bins can be placed in pairs to separate lead mailpieces from trail mailpieces. It is desirable for the mailpieces in each output bin to face identically. The operator may thus rotate trays properly so as to orient lead and trail mailpieces the same way. The mail may be separated into four broad categories: (1) facing identification marks (FIM) used with a postal numeric encoding technique, (2) outgoing (destination is a different sectional center facility (SCF)), (3) local (destination is within this SCF), and (4) reject (detected double feeds, not possible to sort into other categories). The decision of outgoing vs. local, for example, may be based on the image analysis performed by the image server 327.

FIG. 8 illustrates a computer system 350 that can be employed to implement systems and methods described herein, such as based on computer executable instructions running on the computer system. The computer system 350 can be implemented on one or more general purpose networked computer systems, embedded computer systems, routers, switches, server devices, client devices, various intermediate devices/nodes and/or stand alone computer systems. Additionally, the computer system 350 can be implemented as part of the computer-aided engineering (CAE) tool running computer executable instructions to perform a method as described herein.

The computer system 350 includes a processor 352 and a system memory 354. Dual microprocessors and other multi-processor architectures can also be utilized as the processor 352. The processor 352 and system memory 354 can be coupled by any of several types of bus structures, including a memory bus or memory controller, a peripheral bus, and a local bus using any of a variety of bus architectures. The system memory 354 includes read only memory (ROM) 358 and random access memory (RAM) 360. A basic input/output system (BIOS) can reside in the ROM 358, generally containing the basic routines that help to transfer information between elements within the computer system 350, such as a reset or power-up.

The computer system 350 can include one or more types of long-term data storage 364, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 352 by a drive interface 366. The long-term storage components 364 provide nonvolatile storage of data, data structures, and computer-executable instructions for the computer system 350. A number of program modules may also be stored in one or more of the drives as well as in the RAM 360, including an operating system, one or more application programs, other program modules, and program data.

A user may enter commands and information into the computer system 350 through one or more input devices 370, such as a keyboard or a pointing device (e.g., a mouse). These and other input devices are often connected to the processor 352 through a device interface 372. For example, the input devices can be connected to the system bus 356 by one or more a parallel port, a serial port or a universal serial bus (USB). One or more output device(s) 374, such as a visual display device or printer, can also be connected to the processor 352 via the device interface 372.

The computer system 350 may operate in a networked environment using logical connections (e.g., a local area network (LAN) or wide area network (WAN) to one or more remote computers 380. The remote computer 380 may be a workstation, a computer system, a router, a peer device or other common network node, and typically includes many or all of the elements described relative to the computer system 350. The computer system 350 can communicate with the remote computers 380 via a network interface 382, such as a wired or wireless network interface card or modem. In a networked environment, application programs and program data depicted relative to the computer system 350, or portions thereof, may be stored in memory associated with the remote computers 380.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for reading the value of a metermark, comprising:
producing a binarized image via a first binarization technique;
identifying a plurality of character regions within the image;
identifying at least one character string, a given character string comprising a plurality of identified character regions;
classifying the plurality of character regions comprising a given character string to generate a confidence value for the string;
accepting the classified character string if the confidence value meets the threshold; and
producing a second binarized image for analysis, using a second binarization technique, if the confidence value does not meet the threshold.

2. The method of claim 1, wherein classifying the plurality of character regions comprising a given character string comprises:
classifying the plurality of character regions at a first classifier;
determining a confidence value associated with the character string at the first classifier; and
classifying the plurality of character regions at a second classifier if the determined confidence value is less than a second threshold value.

3. The method of claim 2, wherein classifying the plurality of character regions comprising a given character string further comprises selecting a first classifier from a plurality of available classifiers according to at least one characteristic of the character string.

4. The method of claim 2, wherein the at least one characteristic of the character string comprises a degree of fragmentation of the character regions comprising the character string.

5. The method of claim 1, wherein identifying a plurality of character regions within the image comprises combining contiguous regions of dark pixels that are separated by less than a threshold distance into character regions.

6. The method of claim 1, wherein identifying at least one character string, a given character string comprising a plurality of identified character regions comprises grouping together character regions that are horizontally proximate and similar in height and vertical centering.

7. A computer program product, operative in a data processing system and stored on a computer readable medium, that determines an associated value of a metermark comprising:
an image processing element that is operative to produce a first binarized image via a first binarization technique and a second binarized image via a second binarization technique;
a region identifier that identifies a plurality of regions of connected pixels in the first binarized image;
a clustering element that combines the identified regions into at least one character string, a given character string comprising a plurality of characters;
an optical character recognition system that classifies each of the plurality of characters comprising a given string into one of a plurality of character classes;
a string verification element that determines a confidence value for a given string according to its classified plurality of characters, accepts the string if the confidence value meets a threshold value, and provides a reject signal to the image processing unit to instruct the image processing unit to produce the second binarized image if the confidence value does not meet a threshold value.

8. The computer program product of claim 7, the optical character recognition system comprising a plurality of classifiers, the optical character recognition system being operative to select between at least a first classifier and a second classifier based upon at least one characteristic of the character string, such that the selected classifier is used to classify the plurality of characters comprising the character string.

9. The computer program product of claim 8, the first classifier comprising a neural network designed to recognize characters designed to identify machine printed text that can have characters that are not completely formed and the second classifier comprising a neural network designed to identify characters that are highly fragmented.

10. The computer program product of claim 8, the optical character recognition system comprising a third classifier that can be used to classify the plurality of characters comprising the character string if a confidence value associated with the selected classifier is below a threshold value.

11. The computer program product of claim 10, the third classifier comprising a neural network designed to recognize hand written text.

12. The computer program product of claim 7, the region identifier being operative to group regions of connected pixels that are separated by less than a threshold distance into a character.

13. The computer program product of claim 12, the region identifier being operative to group characters into character strings according to at least one of similarities in height, similarities in vertical centering, and horizontal proximity.

14. A system for metermark value recognition, comprising:
a plurality of binarization elements, each being operative to produce a binarized image from a source image;
a clustering element that clusters pixels within a first binarized image, produced at a first of the plurality of binarization elements, to locate at least one character string;
a classification element that identifies a plurality of characters comprising the located character string; and
a verification system that evaluates the identified plurality of characters and instructs a second of the plurality of binarization elements to produce a second binarized image if the identified characters are determined to be unreliable.

15. The system of claim 14, wherein the plurality of binarization elements comprises a threshold binarization element that produces a binarized image by comparing the brightness of each pixel within the source image to a threshold value, such that pixels having a brightness value below a threshold value are represented as dark pixels and pixels having a brightness exceeding the threshold value are white pixels.

16. The system of claim 14, wherein the plurality of binarization elements comprise a bandpass binarization component that produces a binarized image by comparing the brightness of each pixel within the source image to a range of values representing dark pixels, such that pixels having a brightness value within the range are represented as dark pixels and pixels having a brightness outside of the range are white pixels.

17. The system of claim 14, wherein the plurality of binarization elements comprise an edge detection binarization component that produces a binarized image by applying an edge detection algorithm to the source image.

18. The system of claim 14, the clustering element being operative to group regions of connected pixels that are separated by less than a threshold distance into a character.

19. The system of claim 18, the clustering element being operative to group characters into character strings according to at least one of similarities in height, similarities in vertical centering, and horizontal proximity.

20. The system of claim 14, the verification system being operative to determine a confidence value for the character string according to a plurality of character confidence values associated with the plurality of characters and contextual evidence that the character string contains value information.
